(19) United States
(12) Patent Application Publication
(10) Pub. No.: US 2005/0005719 A1
(43) Pub. Date: Jan. 13, 2005

(54) Method for generating a non-inertial coriolis force and its application to an internal propulsion device in a closed system

(76) Inventor: Byung-Tae Chung, Incheon-Shi (KR)

Correspondence Address: Peter T. Kwon;G W i P S, Kangnam P.O. Box 2301, Seoul, 135-242, KR

(21) Appl. No.: 10/461,473

(22) Filed: Jun. 16, 2003

(51) Int. Cl. F16H 27/04

(52) U.S. Cl. 74/84 S

(57) ABSTRACT

A method of generating mobility in an internal propulsion apparatus of a closed system utilizing the non-inertial Coriolis force comprises the steps of: locating at least two masses (M1, M2), at both ends of an axis, each of which mass has a radius (r) from the mass center of masses (MCM); generating the Coriolis force at the center of mass 2 (M2) by applying torque (−Tc) to the rotating direction with respect to the rotating center (RCM) of mass 1 (M1), while the radii (r) of the two masses (M1, M2) are varied and the two masses (M1, M2) are rotating at equal velocity with respect to the rotating center (RCM) of mass 1 (M1); the mass 2 (M2) is momentarily stopped in order to become the instant center of mass (ICM) by the Coriolis force, then mass 1 (M1) is rotated to generate a non-initial Coriolis force, after τ seconds, with respect to the mass center of mass (MCM); after the Coriolis force (fc) is generated and a certain period of time has elapsed, a reverse Coriolis force (fc′) is generated in the opposite direction of the Coriolis force (fc) as a reaction against the Coriolis force (fc); and a locomotive force (f) is generated for moving the closed system according to the vector sum of the Coriolis force (fc) and the reverse Coriolis force (fc′).

### BACKGROUND OF THE INVENTION

1. Field of the Invention

The present invention relates to a method for generating a Coriolis force in a closed system and its application to a device for generating mobility according to the rotation of mass in a closed system. Particularly, the Coriolis force (fc) represents the forces acting on the total center of mass (TCM) in an inertial coordinate system when the observed masses (M1, M2) located at certain radii (r) from the center of mass in an angular coordinate system rotate with a constant angular velocity (ω) while the radii of the masses are simultaneously varied.

2. Related Prior Art

As a conventional technology, U.S. Pat. No. 6,109,123, entitled “Rotational Inertial Motor,” discloses an internal propulsion device of a closed system.

The reference describes that an inertial drive unit utilizes the reaction of an apparatus to the longitudinal component of the radial acceleration of rotating masses internal to the apparatus. Particularly, the internal radial acceleration of masses driven by circular motion is induced along a linear path, so it creates a reaction force that moves the apparatus in a perpendicular direction, far away from the axis of rotation of the internal constituents of the apparatus.

In the above reference, the vector acceleration of mass in the conventional technology is represented as follows:
a=(a−rω2)ρ+(2vω+rα)θ
wherein, a is scalar radial acceleration, d²r/dt², and α is scalar angular acceleration, d²c/dt².

Generally, these four accelerations are known as radial acceleration, centripetal acceleration, Coriolis acceleration and angular acceleration. Each acceleration causes a reaction force, F=−ma, wherein the minus sign represents the fact that the accelerations are detected as reactions in a rotating system. Therefore, inertial forces are presented in order to define the radial acceleration force, the centrifugal force, the Coriolis force, and the angular acceleration force. In the prior art, the acceleration (a) and velocity (v) were zero, and its effect relies upon ω and α. The effect of the cited reference relies primarily upon the radial acceleration force (a) and the Coriolis force 2vω (i.e., the forces that result from the radial motion of masses).

However, an important aspect of this reference is that, because the above equation interprets the acceleration representing the total acceleration of the inertial system and the non-inertial system as being not equal to zero (a=/=0), it describes the operation of the apparatus as initially deviating from Newton's Law. Although the Coriolis force and the angular acceleration force are defined as non-inertial forces in this reference, these forces are treated as if the inertial force is generated by external forces. Therefore, the apparatus of this reference cannot achieve the expected mobility.

Because radial acceleration and centripetal acceleration are types of inertial forces, these forces cancel each other out in a rotating system and generate a standstill vibration without linear movement for a vehicle. The above reference misrepresents that mobility is generated by radial acceleration. It is incorrect to assert that these forces may achieve locomotive power.

In order to solve the aforementioned problem, an objective of the present invention is to provide a non-inertial force of the Coriolis force that represents the forces acting on the center of mass in a closed system when the mass of the closed system rotates with constant angular velocity and simultaneously varies the radius from the center of mass. It must be verified that a closed system generates non-inertial linear movement by the Coriolis force.

### SUMMARY OF THE INVENTION

An objective of this invention is to provide a method for generating the non-inertial Coriolis force of the present invention comprises the following steps: locating at least two masses (M1, M2), at both ends of an axis, each mass of which has a radius (r) from the mass center of masses (MCM); generating the Coriolis force at the center of mass 2 (M2) by applying torque (−Tc) to the rotating direction with respect to the rotating center of mass (RCM) of mass 1 (M1), while the radii (r) of the two masses (M1, M2) are varied and the two masses (M1, M2) are rotating at the same velocity with respect to the rotating center of mass (RCM) of mass 1 (M1); momentarily stopping mass 2 (M2), causing it to become, by the Coriolis force, an instant center of mass (ICM); and then rotating mass 1 (M1) in order to generate a non-initial Coriolis force after τ seconds with respect to the mass center of masses (MCM).

According to the present invention, an internal propulsion method of a closed system, utilizing a non-inertial Coriolis force, comprising the following steps: locating at least two masses (M1, M2), at both ends of an axis, each mass of which has a radius (r) from the mass center of masses (MCM); generating the Coriolis force at the center of mass 2 (M2) by applying torque (−Tc) to the rotating direction with respect to the rotating center (RCM) of mass 1 (M1), while the radii (r) of the two masses (M1, M2) are varied and the two masses (M1, M2) are rotating at the same velocity with respect to the rotating center (RCM) of mass 1 (M1); momentarily stopping mass 2 (M2), causing it to become, by the Coriolis force, an instant center of mass (ICM); and then rotating mass 1 (M1) in order to generate a non-initial Coriolis force after τ seconds with respect to the mass center of mass (MCM).

Another objective of the present invention is to provide an internal propulsion device to generate non-inertial linear movement for a closed system by generating the Coriolis force inside of the closed system.

Another objective of the present invention is to provide an internal propulsion device for a closed system, enabling mobility without the use of wheels or external forces, by generating the Coriolis force inside of the closed system.

After the Coriolis force (fc) is generated and a certain period of time has elapsed, a reverse Coriolis force (fc′) is generated, as a reaction against the Coriolis force (fc), in the opposite direction of the Coriolis force (fc).

A locomotive force (f) is generated for moving the closed system according to the vector sum of the Coriolis force (fc) and the reverse Coriolis force (fc′).

### BRIEF DESCRIPTION OF THE DRAWINGS

FIG. 1 is a schematic drawing illustrating the actions between the rotating masses, which generally are in circular motion with constant velocity.

FIGS. 2a and 2b are a conceptual drawing illustrating the concept of operation in a closed system, according to the present invention.

FIG. 2a represents an operation of an opened system.

FIG. 2b represents an operation of a closed system.

FIG. 3 is a force exertion diagram representing the generated Coriolis force with time, according to the present invention.

FIG. 4 is a vector diagram representing the generated Coriolis force, according to the present invention.

FIG. 5 is a vector diagram for a hemisphere-type internal propulsion apparatus utilizing the Coriolis force, according to the present invention.

### DETAILED DESCRIPTION OF THE PREFERRED EMBODIMENT

In order to achieve the aforementioned objective, the principle of the Coriolis force in a closed system and its application are provided in the present invention. A detailed description is presented, along with accompanying drawings.

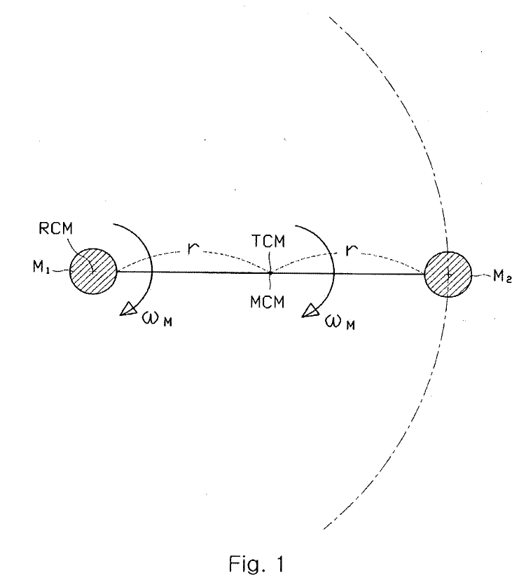

Referring to FIG. 1, if mass 1 (M1) is rotated with respect to the rotating center (RCM) of mass 1 (M1), two masses (M1, M2) start to rotate with respect to the mass center (MCM) of masses. At this moment, the system will spin at the mass center of masses (MCM), with constant rotating velocity, because the radial acceleration and the centripetal acceleration are acting on the same line and magnitude, i.e., the vector sum of the system is zero because no time will have elapsed.

First of all, it is necessary to define the conceptual movement of an opened system and a closed system in order to explain the characteristics of the Coriolis force, according to the present invention.

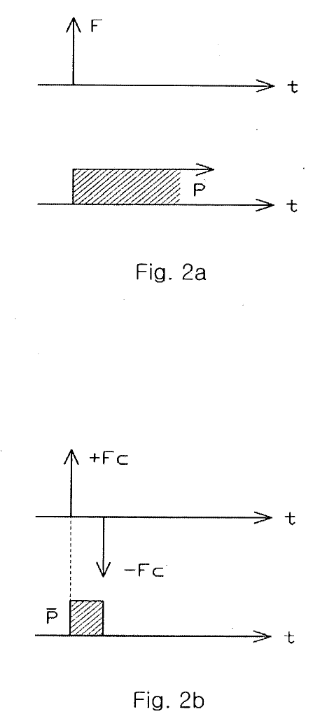

As illustrated in FIG. 2, there are two kinds of object moving means, i.e., opened movement and closed movement. Herein, opened movement occurs when an object is forced by external force (F) and continuously moved by inertial force. (As seen in FIG. 1, a Momentum (P) is continuously presented). On the other hand, closed movement occurs when an object is forced onward and rearward for a certain period of time (e) by coupled external forces (+Fe, −Fe). (As seen in FIG. 1b, a Momentum (\overline{P}) is momentarily presented, and vanishes.)

Accordingly, the force generating opened movement is inertial force, and the force generating closed movement is non-inertial force. The resulting momentum presents and then cancels each other out at opposite directions for a certain period of time.

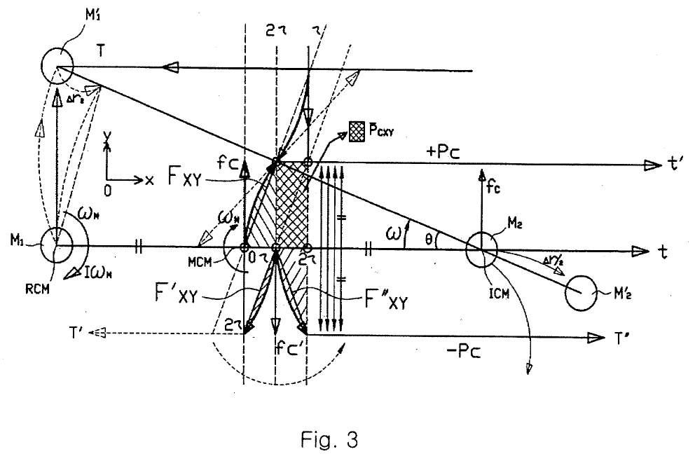

Referring to FIGS. 1 and 3, while mass 1 (M1) is rotating with constant velocity to maintain a constant angular velocity (ωM) of mass 1 (M1) with respect to the rotating center of mass 1 (RCM), the radius (r) is simultaneously varied with Δr/2 and applies a torque ^{-f}_{c} of IωM to the rotating direction.
Then, a reaction force (fc) is presented on mass 2 (M2):

$${\text{?}}_{c} = \text{?} \text{?} \frac{ⅆ}{ⅆ} \text{?} - {ω}_{M} 2 {n}^{-} {M}_{2} - r \text{?} \text{?} \\ \text{?} \text{indicates text missing or illegible when filed} \qquad ( 1 )$$

wherein, the force (fc) represents the Coriolis force.

At this instance, mass 2 (M2) will be momentarily stalled and becomes the rotation center of mass (RCM). Simultaneously, the radius (r) is increased from the rotation center of mass 1 (RCM), and a force (fc) is presented at the mass center of masses (MCM), while the momentum energy is maintained constant (ωM=constant) for τ seconds: as represented below.
F_{XY}≈f_{c} cost δ(t)
After τ seconds, a reaction force is generated on mass 1 (M1) with respect to an instant center of mass (ICM), as follows;
F_{XY}≈f_{c} cos δ(t-τ)
When the axis f time is moved from T′ to T″, the forces

F′_{XY}>F″_{XY} become F″_{XY} F′_{XY}.

At this point, the centrifugal force and centripetal force are simultaneously generated, but the forces cancel each other out. When the angular velocity (ω) is constant, a relation is established, as follows:
F_{XY}^{δ}(t)−F_{XY}^{δ}(t−=) 0- - - \mathring{2}

When above equation α is integrated for τ seconds, wherein
x(t)⁻x(t)−x(t−τ)

$${\int }_{}^{\text{?}} {F}_{XY} \text{?} ( τ ) ⅆ t - {F}_{\text{?}} [ u ( t ) - u ( t - τ ) ] - {\text{?}}_{\text{?} \text{?} \text{?}} \\ \text{?} \text{indicates text missing or illegible when filed} \qquad 3 ◯$$

the equation β is a closed movement—that is, a Pulse movement.
When the equation α is again integrated for τ seconds, at u(t)⁻u(t)−u(t−τ)

$${\int }_{0}^{\text{?}} {F}_{XY} \overline{u} ( 1 ) ⅆ \text{?} C \text{?} 0$$

$$\text{?} \text{indicates text missing or illegible when filed}$$

—that is,

$${\int }_{0}^{\text{?}} {\text{?}}_{\text{?} \text{?} \text{?}} ⅆ \text{?} M {\text{?}}^{X \text{?}} {C}_{\text{?} \text{?}} \text{?} \text{?}$$

$$\text{?} \text{indicates text missing or illegible when filed}$$

wherein, C=mass×distance, the amount of movement of the system with respect to the total center of mass (TCM) will be

$${L}_{\text{?}}^{\text{?} \text{?}} \frac{M {\text{?}}^{\text{?} \text{?}}}{2 M} . \\ \text{?} \text{indicates text missing or illegible when filed}$$

In this manner, after the Pulse movements are generated, whenever multiple steps of the instant center of mass (ICM) occur, non-inertial separated movements can be obtained every τ seconds.
The more accurate value of F_{XY} is as follows:

$${F}_{XY} \int \text{?} r \text{?} cos θ d θ$$

$$\text{?} \text{indicates text missing or illegible when filed}$$

Therefore, it is necessary to supply energy when the radius (r) is extended and all masses are rotating with constant angular velocity (ω=constant) with respect to the rotating center of mass (RCM). Contrarily, if the radius (r) is decreased, an impulse of the Coriolis force (−fc) is generated due to the reverse energy supply or energy recovery. The Pulse movement as the closed movement is generated as a result of the alternative occurrence of rotating masses and the rotating center of mass (RCM).

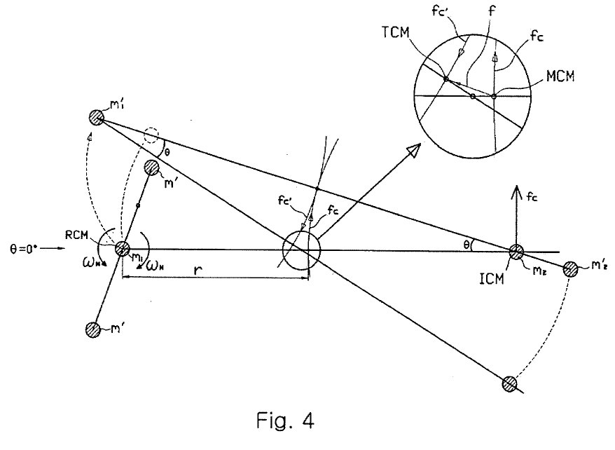

As seen in FIG. 4, after the Coriolis force (fc) is generated with respect to the rotating center of mass (RCM), and a certain period of time has elapsed (τ seconds), the reverse Coriolis force (fc′) is generated, as a reaction against the Coriolis force (fc), in the opposite direction of the Coriolis force (fc). A locomotive force (f) is generated for mobilizing the closed system forward according to the vector sum of the Coriolis force (fc) and the reverse Coriolis force (fc′). Therefore, the total mass center of the closed system is substantially forwarded by this locomotive force (f).

As described above, when the masses (M1, M2), rotating with constant angular velocity (ω) at the center of mass (CM), and the radii (r), simultaneously varying, are placed in a closed system, it is possible to achieve linear movement for a closed system as the total center of mass (TCM) of the closed system moves forward.

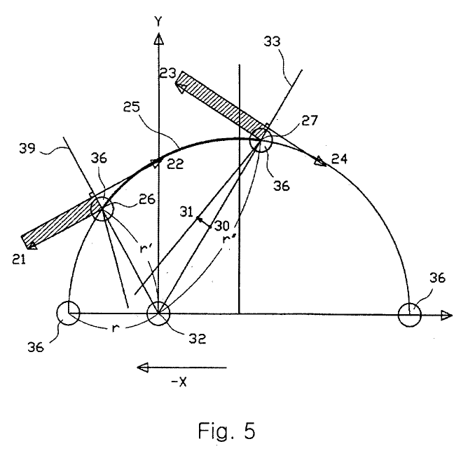

As seen in FIG. 5, an internal propulsion apparatus of the present invention is modeled. This model illustrates that Coriolis forces (fc: 21, 22, 23, 24) are presented on a trajectory of momentary Centroid (25) which is trajecting the momentary centers (26, 27) of the core mass (36). This model of the present invention illustrates the relationship between the momentary center (26, 27) and the Coriolis force (fc).

When a core mass M (35) in a system rotates with constant velocity (ω=constant) at a certain point of rotating axis (39), and the core mass M (35) is constantly moved away from the core mass m (36), an instant center of mass (ICM) (26, 27) is presented at a certain point of the core mass m (36). Then, Coriolis forces (fc: 21, 22, 23, 24) are generated at an instant center (ICM) of masses (26, 27) perpendicular to the axis of instant center (33, 39), connecting the rotating center (RCM) of mass (32) to the core mass m (36). The instant center (ICM) of masses (26, 27) is traced along the trajectory of momentary Centroid (25). Since Coriolis forces (fc) are presented on the instant center (ICM) of masses (26, 27), the rotating center of mass (RCM) (32) will be traced along an arc with respect to the instant center (ICM) of mass (38) by reaction force. Consequently, the total center of core mass (TCM) (30) is moved forward (relocated from point 30 to point 31) as the mass center of masses (MCM) (30) is rotated with respect to the axis of the instant center (33).

In this case, the Coriolis forces (Fc) generated by action of the rotating center of mass (RCM) (32) and instant center of mass (ICM) (26, 27) first reacts in an inertial coordinate system and later reacts in a rotating coordinate system. That is, it is possible to apply the equation □ due to the occurrence of phase delay in time for action and reaction between the coordinate systems.

In the case where the radius (r) is varied and an angular velocity (ω) is constant, if the mass is separately accelerated on the rotating center of mass (RCM) (32), it could be described as shown in the following equation \mathring{1}

$$ⅆ \text{?} \text{?} = τ \text{?} = \text{?} c$$

$$\text{?} \text{indicates text missing or illegible when filed}$$

wherein, Fc is a temporarily presented resultant due to the inertial core mass I.

Referring to FIG. 5. the core mass m (36) rotates clockwise with respect to the rotating center of mass (32) under the condition of extending the radius (r) simultaneously with constant angular velocity (ω=constant). In this situation, the overall closed system is moved in the −X direction. Sequentially, the core mass m (36) moves completely rightward, rotating counterclockwise under the condition of shortening the radius (r) simultaneously with constant angular velocity (ω=constant). In this situation, the overall closed system is also moved in the −X direction.

That is, the overall closed system is moved to the negative (−) direction at the smallest position of line segment (r) connected to the core mass m (36) and the core mass M (35). When a mechanism as shown in FIG. 5 operates inside of a closed system, the closed system is capable of moving forward by locomotive force (f), which force is delivered by way of the Coriolis force of the closed system.

This invention can be extensively applied not only in the space-engineering field, but also in transportation industries. For example, it may be applied to satellites, space shuttles, space stations, space personal lifeboats, wheel-less toys, conveyors and transporting devices. It can also be utilized in propulsion apparatuses such as airplanes, vessels and submarines and their respective brake systems, as well as nano-sized capsules that require precise movement for traveling inside of the human body.

According to the present invention, it is possible to obtain movement for a closed system by utilizing non-inertial Coriolis forces without applying external forces. Since a closed system has non-inertial separation movement by non-inertial Coriolis forces, it has the capability of instantly changing the direction movement of a closed system by the momentarily holding action of the Coriolis force in the closed system. Because it is possible to obtain closed movement, especially in a closed system within a gravity-free field, the direction of a moving object may be momentarily changed without external force. Further, it is possible to control minute movements and instant stops. Moreover, a closed system does not allow for the exchange of foreign objects such as an internal combustion engines or rockets, so there is no possibility of polluting the environment.

While the present invention has been described in detail with its preferred embodiments, it will be understood that further modifications are possible. The present application is therefore intended to cover any variations, uses or adaptations of the invention, following the general principles thereof, and includes such departures from the present disclosure as come within known or customary practice in the art to which this invention pertains, within the limits of the appended claims.

1. A method for generating a non-inertial Coriolis force in a closed system comprises the steps of:
locating at least two masses (M1, M2), at both ends of an axis, each of which mass has a radius (r) from the mass center of masses (MCM);
generating the Coriolis force at a center of mass 2 (M2) by applying torque (−Tc) to the rotating direction with respect to the rotating center of mass (RCM) of mass 1 (M1), while the radii (r) of the two masses (M1, M2) are varied and the two masses (M1, M2) are rotating at the same velocity with respect to the rotating center of mass (RCM) of mass 1 (M1); and
the mass 2 (M2) is momentarily stopped to become an instant center of mass (ICM) by the Coriolis force, then mass 1 (M1) is rotated to generate a non-initial Coriolis force, after τ seconds, with respect to the mass center of masses (MCM).

2. A method for generating mobility in an internal propulsion apparatus utilizing non-inertial Coriolis force of closed system comprises the steps of:
locating at least two masses (M1, M2), at both ends of an axis, each of which mass has a radius (r) from the mass center of masses (MCM);
generating the Coriolis force at the center of mass 2 (M2) by applying torque (−Tc) to the rotating direction with respect to the rotating center (RCM) of mass 1 (M1), while the radii (r) of the two masses (M1, M2) are varied and the two masses (M1, M2) are rotating at the same velocity with respect to the rotating center (RCM) of mass 1 (M1);
the mass 2 (M2) is momentarily stopped to become an instant center of mass (ICM) by the Coriolis force, then mass 1 (M1) is rotated to generate a non-initial Coriolis force, after τ seconds, with respect to the mass center of mass (MCM);
after the Coriolis force (fc) is generated and a certain period of time has elapsed, a reverse Coriolis force (fc′) is generated, in the opposite direction of the Coriolis force, (fc) as a reaction against the Coriolis force (fc); and
a locomotive force (f) is generated for moving the closed system according to the vector sum of the Coriolis force (fc) and the reverse Coriolis force (fc′).

3. A method for generating mobility in an internal propulsion apparatus as claimed in claim 2, wherein said closed system is moved in the negative (−) direction at the smallest position of line segment (r) connected to mass 1 (M1) and mass 2 (M2).
